(19) United States
(12) Patent Application Publication
(10) Pub. No.: US 2005/0192829 A1
(43) Pub. Date: Sep. 1, 2005

(54) Methods and apparatuses for renting items

(76) Inventors: Michael Van Zandt, Sunnyvale, CA (US); Judah Van Zandt, Sunnyvale, CA (US); Patience Van Zandt, Sunnyvale, CA (US); Patrick Van Zandt, Sunnyvale, CA (US); Thomas Van Zandt, Sunnyvale, CA (US)

Correspondence Address: Thomas Van Zandt, 5255 Stevens Creek Blvd. #299, Santa Clara, CA, 95051, US

(21) Appl. No.: 11/055,672

(22) Filed: Feb. 11, 2005

Related U.S. Application Data
(60) Provisional application No. 60/547,452, filed on Feb. 26, 2004.

(51) Int. Cl. G06F 17/60

(52) U.S. Cl. 705/1; 705/35

(57) ABSTRACT

In accordance with various embodiments of the invention, a rental method and apparatus is described that provides the ability to effect a rental transaction and provide a user with access to the selected rental item. In accordance with one embodiment of the invention, a user accesses descriptions of available rental items via a DPS. The user then selects a desired rental item and effects a rental transaction agreement via the DPS. Upon completion of the rental transaction agreement, the user is automatically provided access to the selected rental item. In accordance with one embodiment of the invention the selected rental item is proximate to the DPS (e.g., within a same commercial location) and the selected rental item is provided to the user promptly (e.g., within several minutes).

### CLAIM OF PRIORITY

This application is related to, and hereby claims the benefit of provisional application No. 60/547,452 entitled “Methods and Apparatuses for Renting Items”, which was filed Feb. 26, 2004.

### FIELD OF THE INVENTION

Embodiments of the invention relate generally to the field of renting consumer items and more specifically to methods and apparatuses for automatically completing a rental transaction and providing the rental item.

### BACKGROUND

Many consumer items that were once purchased outright may now be rented. For example, audio and video content in the form of audio or video tapes or audio or video disks (e.g., compact disks (CDs) or digital video disks (DVDs)) have been available for rent for several years. Typically, a video rental provider maintains a rental location (e.g., a store front). The renter (user) goes to the rental location and peruses a number of available rental items that are on display at the rental location. The user may ask a store clerk (provider representative) to check the availability of a specific rental item by accessing a database on a digital processing system to determine availability. Typically, the user does not have access to such stored information. The user then selects a desired rental item and completes a rental transaction that involves presenting the selected rental item to a provider representative and paying or agreeing to pay the rental fee.

This method of renting items has several disadvantages. One disadvantage is that a provider representative must be available to record the rental transaction and receive payment. Such representatives are expensive and result in an increased rental fee for the rental item. Moreover, a user may not wish to effect the rental transaction with the involvement of another person (i.e., the user may not wish to present the selected item to a person) for various reasons.

Another disadvantage is that a great deal of space may be required to display the available rental items. Since the display space is proximate to the rental transaction, it is typically in an area of high commerce. This commercial space may be quite expensive, again resulting in an increased rental fee. Moreover, the cost of display space will limit the number and variety of rental items that may be displayed. This may lead to lost business if a user's selection is not available.

These disadvantage have been at least partially overcome by the advent of on-line providers of rental items. Such a provider effects a rental transaction over a network, typically using a digital processing system (DPS). The available rental items are fully described via the (DSP) through text, graphics, and/or audio-video presentations so that the user may make informed selections. Though the rental items are not physically available for review, an on-line description is typically sufficient, and in many cases may be far superior to a physical inspection by the user. For example, consider a movie rental. The on-line description may provide a synopsis, reviews by critics, still pictures, and video clips of the movie. This is much more information than a user can obtain by looking at the physical tape or disk container. After the user selects a rental item, the selected rental item is then delivered to the user at a specified location of the user.

This method of renting items addresses some of the disadvantages of the previous method. The provider no longer has to compensate a representative to complete the rental transaction. The user no longer has to present the rental item to a provider representative. Also, the rental items need not be displayed in expensive commercial space, but can be stored for shipment upon request in less valuable space.

This on-line rental method has its own disadvantages however. There is an amount of time from the completion of the rental transaction until the delivery of the rental item, which may present an inconvenience to the user. Typically for an on-line movie rental, the rental item (e.g., tape or DVD) is mailed or delivered via some commercial delivery service, which could take from 1-3 days. In whatever manner the rental item is delivered, it takes time and money and therefore increases the rental fee.

Another disadvantage of the on-line rental method is that, until delivery, the user cannot tell if the rental item is defective in some way or even if the delivered item is the item selected (requested). If the delivered item is defective or is not what was ordered, then the delivered item must be returned to the provider and a replacement delivered. This adds to the time between rental transaction and use of the rental item by the user, and also adds to the overall expense of such a rental method and therefore results in increased rental fees.

### BRIEF DESCRIPTION OF THE DRAWINGS

The invention may be best understood by referring to the following description and accompanying drawings that are used to illustrate embodiments of the invention. In the drawings:

FIG. 1 is a process flow diagram illustrating a process in which a rental transaction is effected and access to a rental item provided in accordance with one embodiment of the present invention;

FIG. 2 illustrates a system for automatically completing a rental transaction in accordance with one embodiment of the invention.

FIGS. 3A-3G illustrate one embodiment of a dispensing apparatus as known in the art that may be used to effect delivery of a rental item from a rental storage unit to a delivery port of a user interface unit in accordance with one embodiment of the invention;

FIG. 4 illustrates a mechanism for shunting the selected rental item to the appropriate delivery port in accordance with one embodiment of the invention;

FIG. 5 illustrates a rental item storage unit with access-controlled delivery ports for providing a user access to a selected rental item deposited within a specified delivery port;

FIG. 6 illustrates a method by which a user selects a rental item and the component portions of the rental item are integrated and the rental item provided to the user in accordance with one embodiment of the invention;

FIG. 7 illustrates system for receiving an audio or video rental selection and creating a corresponding rental item by recording the audio or video information to be recorded on a media and delivering the media to a user; and

FIG. 8 is a block diagram illustrating one embodiment of a processing system that may be used to send and receive e-mail messages in accordance with an embodiment of the present invention.

### DETAILED DESCRIPTION

Overview

In accordance with various embodiments of the invention, a rental method and apparatus is described that provides the ability to effect a rental transaction and provide a user with access to the selected rental item. In accordance with one embodiment of the invention, a user accesses descriptions of available rental items via a DPS. The user then selects a desired rental item and effects a rental transaction agreement via the DPS. Upon completion of the rental transaction agreement, the user is automatically provided access to the selected rental item. In accordance with one embodiment of the invention the selected rental item is proximate to the DPS (e.g., within a same commercial location) and the selected rental item is provided to the user promptly (e.g., within several minutes). Alternatively, component portions of the rental item may be stored proximate to the DPS and integrated upon completion of the rental transaction agreement and prior to providing access to the user. Alternatively, some component portions of the rental item may be stored proximately to the DPS and some may be stored remotely. In one such an embodiment, the proximately and remotely stored component portions are brought together and integrated upon completion of the rental transaction agreement. Alternatively, the selected rental item is located remotely from the DPS, but the access to the selected rental item is automatically and promptly provided to the user upon completion of the rental transaction agreement, in accordance with one embodiment of the invention. In such an embodiment, the user may then access and retrieve the selected rental item as soon as possible without awaiting a delivery of the selected rental item. In accordance with one such embodiment the user need not present the selected rental item to a provider representative to effect the rental.

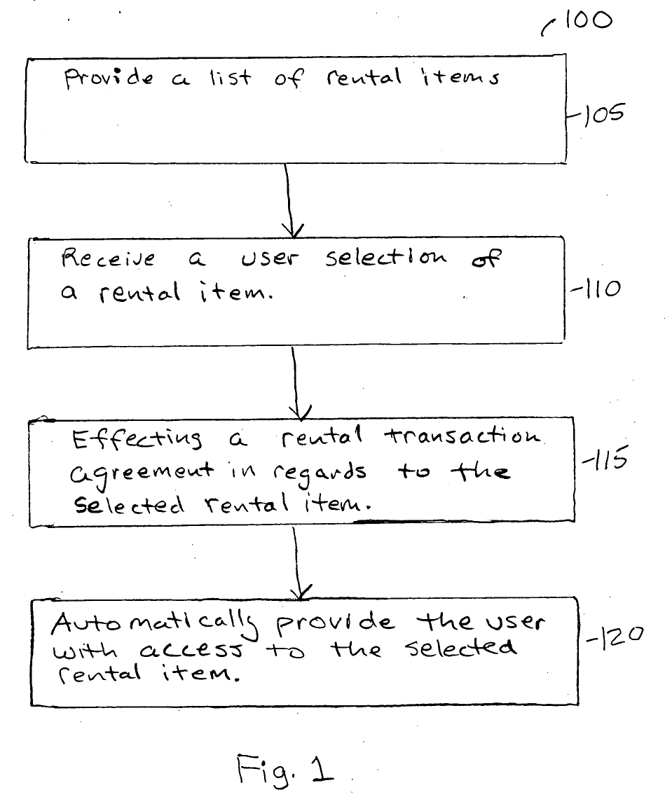

This overview represents some inventive features of various embodiments, which may contain any one of these features alone or in combination. This overview is provided to facilitate the understanding of specific embodiments of the invention discussed below in reference FIGS. 1-8. This overview does not summarize the invention, nor is it intended to be a summary.

In the following description, numerous specific details are set forth. However, it is understood that embodiments of the invention may be practiced without these specific details. In other instances, well-known circuits, structures and techniques have not been shown in detail in order not to obscure the understanding of this description.

Reference throughout the specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout the specification are not necessarily all referring to the same embodiment. Furthermore, the particular features, structures, or characteristics may be combined in any suitable manner in one or more embodiments.

Moreover, inventive aspects lie in less than all features of a single disclosed embodiment. Thus, the claims following the Detailed Description are hereby expressly incorporated into this Detailed Description, with each claim standing on its own as a separate embodiment of this invention.

FIG. 1 is a process flow diagram illustrating a process in which a rental transaction is effected and access to a rental item provided in accordance with one embodiment of the present invention. Process 100, shown in FIG. 1, begins with operation 105 in which a list containing a plurality of rental items is presented for user selection via a DPS. For one embodiment, terms of rental, including the rental fee and any other rental conditions may be presented along with the list of rental items. For one embodiment such terms may have been agreed to beforehand. For one embodiment, the user accesses a list of rental items stored on the DPS. In an alternative embodiment, the user may use the DPS to access, via a network, a server DPS storing the rental items. Each rental item may contain an accompanying description in audio and/or visual format. The rental items may be categorized in a variety of ways to facilitate the identification of a specific desired one or more rental items in accordance with one embodiment of the invention.

At operation 110 the user selection of one or more rental items from the plurality of rental items presented is received. For one embodiment the selection of a rental item initiates a rental transaction agreement and the user may be asked to verify acceptance of the agreement terms.

At operation 115, a rental fee payment or promise to pay is received thus effecting the rental transaction agreement.

At operation 120 the user is automatically provided with access to the selected rental item after completion of the rental transaction agreement. For one embodiment of the invention, information allowing access to the rental item is provided within 10-30 seconds of completion of the rental transaction agreement. For one embodiment in which the rental items are stored proximate to the DPS, the automatically provided access to the selected rental item allows the user to obtain the selected rental item promptly (within several minutes) and directly. That is, for such embodiments the selected rental item is automatically provided to the user. In an alternative embodiment the automatically provided access may allow a user to obtain the selected user item at a remote location.

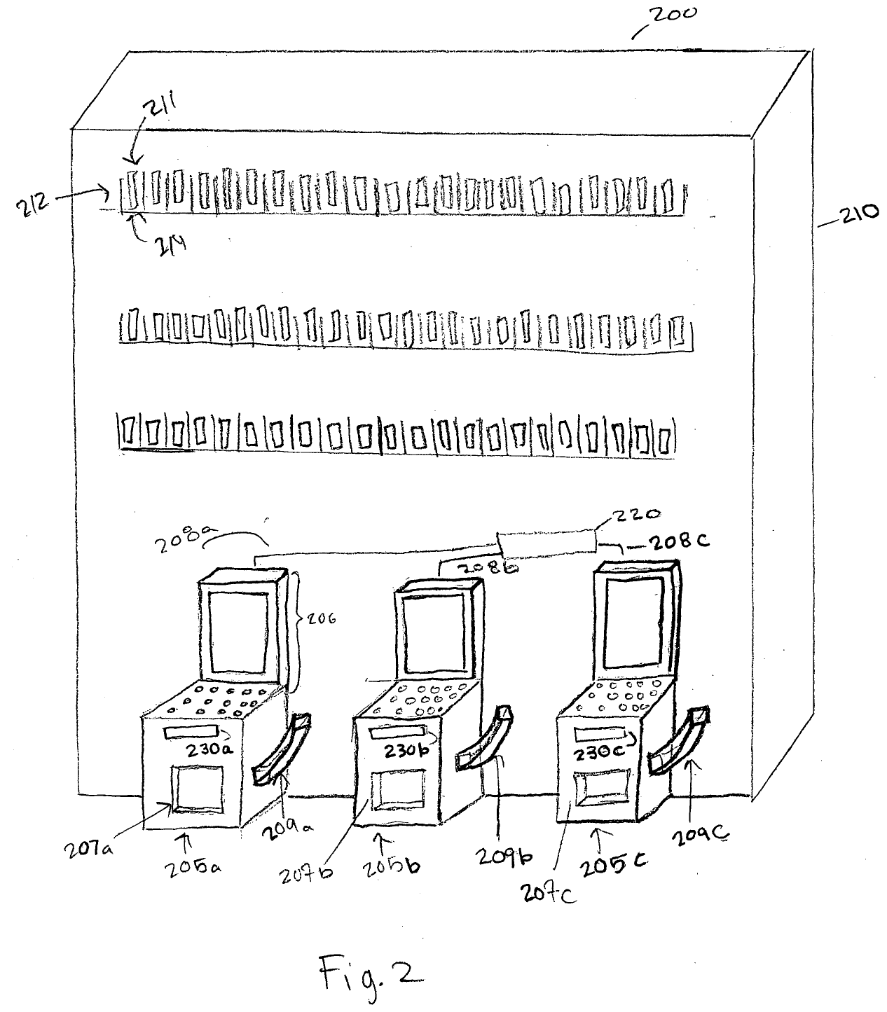

FIG. 2 illustrates a system for automatically completing a rental transaction in accordance with one embodiment of the invention. System 200, shown in FIG. 2 includes a number user interface (UI) units 205, shown here as UI units 205a-205c (the number of UI units may vary depending upon the number of users or other factors including cost and the number of rental items that can be accessed through the users interface units). Each UI unit includes a DPS 206 as known in the art and described more fully below. Each UI unit is electrically and physically coupled to a rental item storage (RIS) unit 210 via electrical connections 208a-208c and physical connections 209a-209c. The RIS unit 210 includes a number of shelves 212 each having a number of individual slots 214 for storing a rental item 211. For example, each slot 214 shown in FIG. 2 may contain a specific DVD. The slots 214 may be fairly uniform in size and sized to fit the particular rental item. The size of slots 214 may also be adjustable so as to accommodate an irregularly-sized rental item. The configuration of the RIS unit and the configuration of the rental items within the RIS unit are not critical aspects of the inventive concepts claimed herein, and may assume various forms in accordance with alternative embodiments. The DPS of each UI unit 205 is used to provide a description of the rental items contained in rental storage unit 210. This means that the rental items 211 need not be displayed to the user because a complete and thorough description may be obtained via the DPS. This allows for greatly reduced storage area of rental items 211. For example, where the rental item is a video or audio presentation (e.g., video or audio tape or DVD/CD), the description may include the actors, artists, authors, critical reviews, and audio and/or video excerpts of the presentation, among other descriptive elements. Other information regarding the rental item, including current availability and price and other terms of the rental transaction agreement, may also be obtained by the user. The DPS 206 may contain all of the information regarding the rental item and rental transaction or may be connected via a network to a server DPS (not shown) that contains some or all of the information.

After a user has selected a rental item and effected a rental transaction agreement via DPS 206. The user may make the required payment via payment port 230 included on UI unit 205 and coupled to the DPS 206. The rental fee may be paid in cash accepted through payment port 230 or may be charged to a credit card account the specific information of which may be provided by the user through payment port 230. The mechanisms through which payment of the rental fee is effected through payment port 230 are known in the art. Alternatively, the user and the provider may have existing payment mechanisms through which to effect rental payment (e.g., a payment account). In such cases the user may arrange payment via information provided through the DPS (e.g., identification of an account and the associated user).

Upon completion of some or all of the various elements of a rental transaction, the user's selection is transmitted to the RIS unit via electrical coupling 208. A controller unit 220 of RIS unit 210 receives the selection information from the DPS 206 and causes the selected item to be delivered from the RIS unit 210 to the UI unit 205 via physical connection 209 which may be a chute sized to accommodate particular types of rental items. The user may then access the rental item through delivery port 207. Effecting the selection of rental item and completion of a rental transaction agreement via the DPS reduces the number of employees necessary to effect rental of the rental items and the user need not present their selected rental item to a person in order to complete the rental transaction.

The mechanisms through which the controller 220 causes the selected rental item to be delivered from the particular storage slot via the physical connection to the delivery port of the corresponding UI unit are known in the art and not critical aspects of the inventive concepts claimed herein, and may assume various forms in accordance with alternative embodiments.

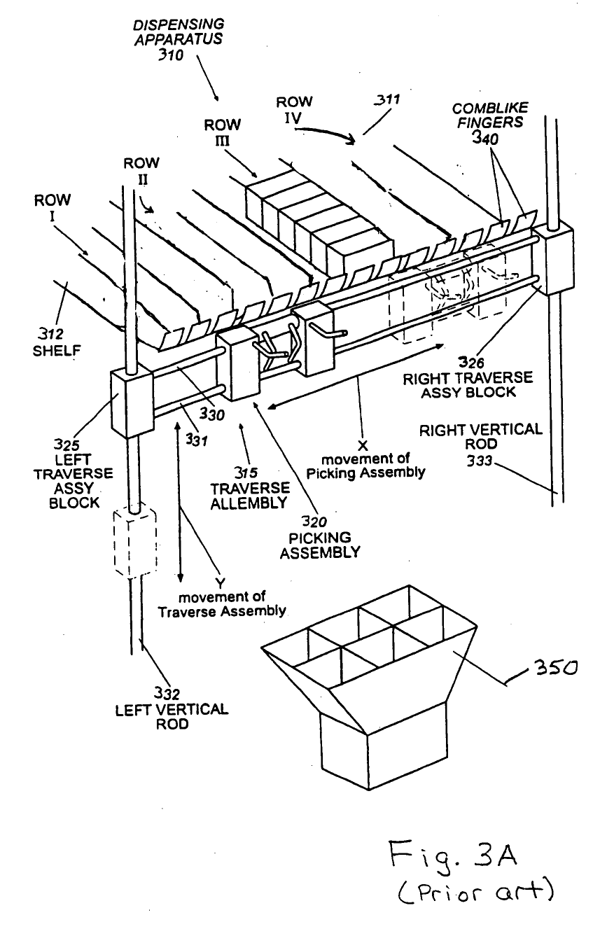

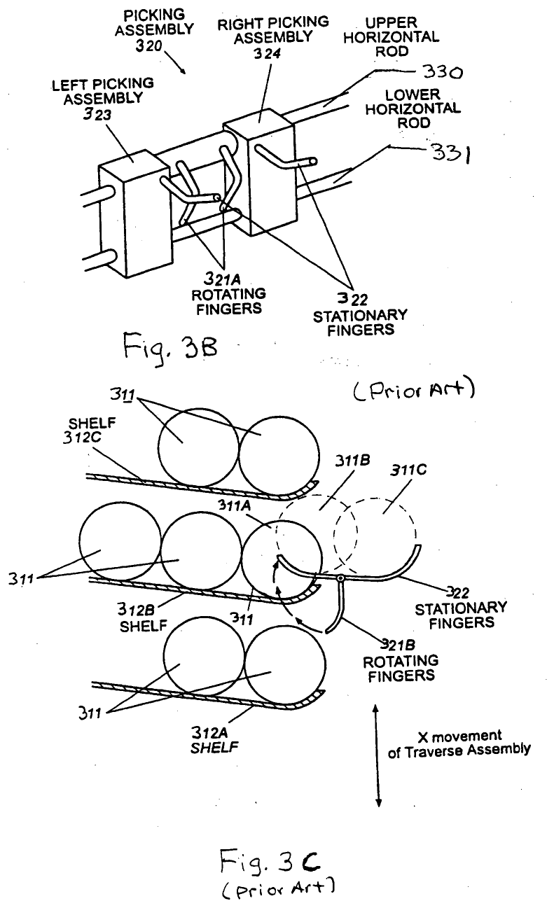

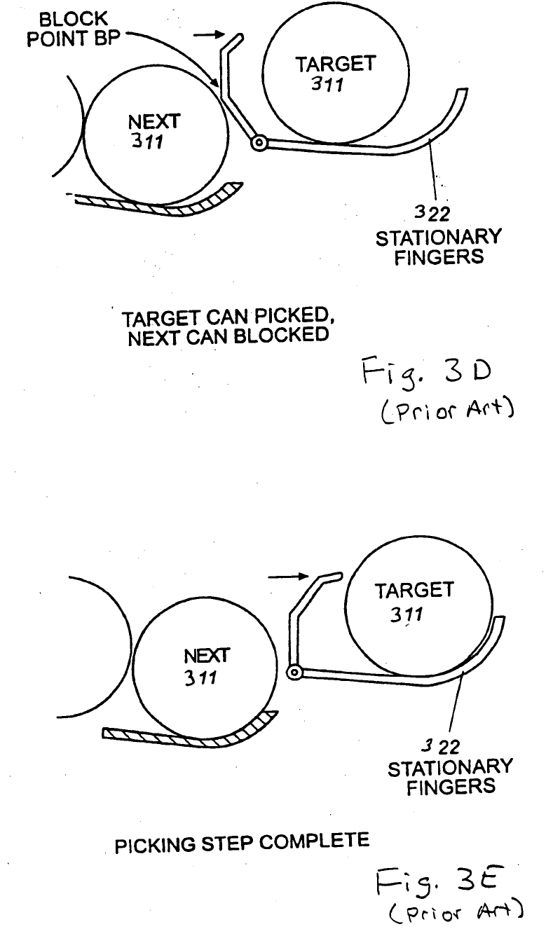

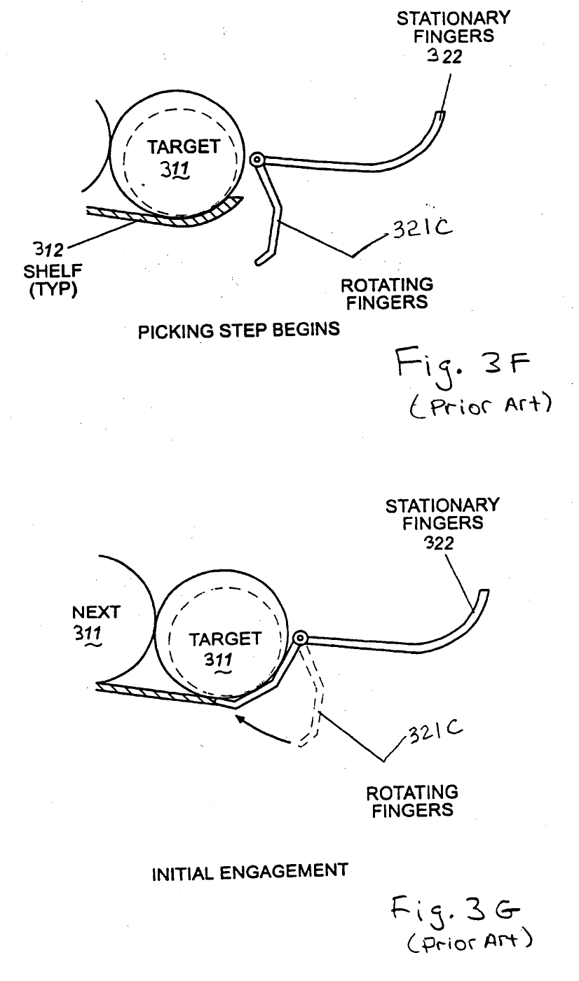

FIGS. 3A-3G illustrate one embodiment of a dispensing apparatus as known in the art that may be used to effect delivery of a rental item from a rental storage unit to a delivery port of a user interface unit in accordance with one embodiment of the invention.

FIG. 3A is an illustrative view of a dispensing apparatus 310 that dispenses rental items 311 (e.g., DVDs) to a waiting user. The rental items are dispensed out of various rows I, II, III, and IV, by use of a picking assembly 320 which is part of a X-Y traverse assembly 315. As shown the rental items 311 may be packaged in containers shaped to facilitate the dispensing apparatus used. For example, DVDs may be packaged in cylindrical containers rather than the typical square package.

Referring also to FIG. 3B, the picking assembly 320 includes rotating fingers 321, stationary fingers 322, and left and right block members 323, and 324, respectively, each of which engage and move horizontally relatively to upper and lower horizontal rods 330, and 331.

By rotating the rotating fingers 321 of the picking assembly 320, the picking assembly 320 can “pick” a rental item, move the rental item to a remote location by means of the X-Y traverse assembly 315, and dispense the rental item as desired.

Referring now to FIG. 3A, the X-Y traverse assembly 315 includes the picking assembly 320, and also includes upper and lower horizontal rods 330, 331, left and right traverse assembly blocks 325, 326, and left and right vertical rods 332, 333.

The left and right vertical rods 332 and 333, extend in a generally coparallel fashion, and are configured to allow for relative vertical movement of the left and right assembly blocks 325 and 326 along their respective heights. This can be done by providing an interaction of the rods 332 and 333 and the blocks 325 and 326 such as used in conventional X-Y plotter technology.

The horizontal rods 330 and 331, have each of their ends mounted in left and right traverse assembly blocks 325 and 326. Left and right block members 323 and 324, each engage and are configured to be moved horizontally relatively across the upper and lower horizontal rods 330, 331. Again the interaction of the rods 330, 331 and the blocks 323, 324 can be such as used in conventional X-Y plotter technology.

The picking assembly 320 is moved along an “X” axis by its relative movement along upper and lower horizontal rods 330, 331. The picking assembly 320 is moved along its “Y” axis by parallel movement of the left and right traverse assembly blocks 325, 326, along corresponding left and right vertical rods 332, 333.

Such movement along the X and Y axes allow for the picking assembly to select (a.k.a. “pick”) rental items, move to a different location, and subsequently release (a.k.a. “release”) them into a single outlet chute (not shown) or into a six-pack container by use of the guide member 50 shown in FIG. 3A.

As noted above, one picking assembly 320 is moved along both an “X” axis and a “Y” axis relative to the frame of the apparatus 310. Referencing FIG. 3B now for more detail, the picking assembly includes not only the previously-discussed left and right picking assembly blocks 323, 324, but also a pair of rotating fingers 321 and a pair of stationary fingers 322.

The pair of stationary fingers 322 are configured to be mounted one each within corresponding left and right picking assembly blocks 323, 324. As will be discussed later, the pair of stationary fingers 322 is configured to provide a “cradle” for the rental item after it is picked by the rotating fingers 321 but before it is discharged by the picking assembly 320.

The rotating fingers 321 rotate in a single direction (although it may be reversible) with such rotation being around a central, substantially horizontal, axis. This pair of rotating fingers 321 is used to “pick” rental item from the front of a row of rental items, with the rotating fingers 321 passing through the comblike fingers 340 in the shelves 312 discussed below.

Besides providing a picking function, as discussed in detail later, the rotating fingers 321 also provide a “block” to the can behind the target can so that the next can does not roll off the shelf under its own momentum.

Reference is now made to FIGS. 3A and 3C, in describing the shelves 312 used to contain the rental items prior to their dispensing. As may be seen in FIG. 3A, four rows I, II, III, and IV of rental items 311 are stored on an exemplary single shelf 312. This shelf is inclined as known in the art and includes dividers as known in the art to provide a plurality of inclined “chutes”, which allow rental item, especially round rental item, to slide or roll down to the front of the shelf under the influence of gravity (spring pressure may be used to assist rectangular or irregular rental item as needed).

At the front edge of the shelf is provided a comblike lip configuration provided by a plurality of spaced-apart “fingers”, which extend generally upwardly from the front edge of the shelf 312, to provide a retention feature for the front can in each row so that it will not fall off. This retention feature, however, can be overcome by the use of the rotating fingers 321 as noted above, which pass through the comblike fingers 340 and allow for the frontmost rental item from a particular row to be withdrawn by the picking assembly 320. There may be more space than fingers in the comb mechanism. However, once programmed the gripper device will be “smart” enough to know where to go to pick the rental item.

Reference is made to FIGS. 3C-3G to describe the relative movement of the rotating fingers 321 as they cooperate with stationary fingers 322 in picking a rental item 311. FIG. 3C is a side illustrative view of a plurality of different rental items 311 loaded within various shelves 312A, 312B, and 312C, also showing by illustration the relative movement of the rotating fingers 321 as they cooperate with stationary fingers 322 in picking a rental item 311 and moving it through positions shown as 311-A, 311-B, and 311-C. The rotating fingers 321 and stationery fingers 322 may be sized so as to accommodate differently sized rental items (e.g., a double-disk DVD or video or audio cassette).

FIGS. 3D-3G are illustrative side views showing sequential steps in the picking process of the rotating fingers 321 and stationary fingers 322, as a target rental item 311 is picked, and a “next” rental item takes its place at the front of the rental item row. In FIG. 3D, the rotating fingers 321 are at the “ready” position. In FIG. 3E, the rotating fingers 321 have rotated from the FIG. 3D position and are passing through the comblike fingers and are contacting the target rental item 311. In FIG. 3F, the rotating fingers 321c have rotated from the FIG. 3E position, and the target rental item 311 has been removed from its row, and is now being supported by the stationary fingers. At the same time, the rotating fingers 321 are “blocking” the next rental item that is moving into the place of the now-picked rental item under the influence of gravity. Such blocking can dissipate the energy in the next rental item to preclude it from jumping over the comblike lip. In FIG. 3G, the rotating fingers 321 have rotated from the FIG. 3F position and the rental item is cradled and ready to be carried by the picking assembly 320 to be discharged at a remote location. The “next” rental item is now in place to be picked next if so desired.

It should be understood that in some instances it has been recognized that the shelf above the item being picked sometimes assists retention of the item as it is being picked, in that the shelf above blocks the item from falling out of the rotating fingers.

Once the selected rental item has been picked by the picking assembly 320, it can then be carried by the picking assembly 320 to be discharged at a remote location. Such discharge can take many forms. One type of discharge can be by bringing the rental item downwardly until one end contacts a stationary surface, thus tipping the rental item out of the cradle of the picking assembly 320 such that it can fall under the influence of gravity to a waiting chute or guide member (such as 350 in FIG. 3A).

Alternatively, the rental item could be lowered downwardly on to an inclined ramp, with the inclined ramp being positioned between the two stationary fingers 322. Alternately, one of the stationary fingers 322 could “drop-out”, allowing release of the rental item without contact with any other device.

Once dispensed from the slot, the selected rental item can delivered to the delivery port of the UI unit as described in FIG. 2. The selected rental item can be shunted to the corresponding UI unit's delivery port in a number of ways.

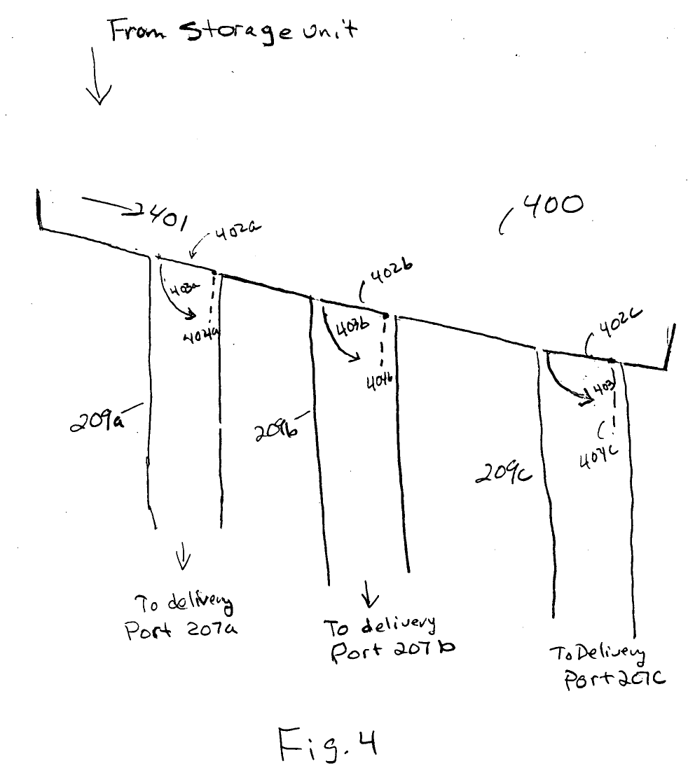

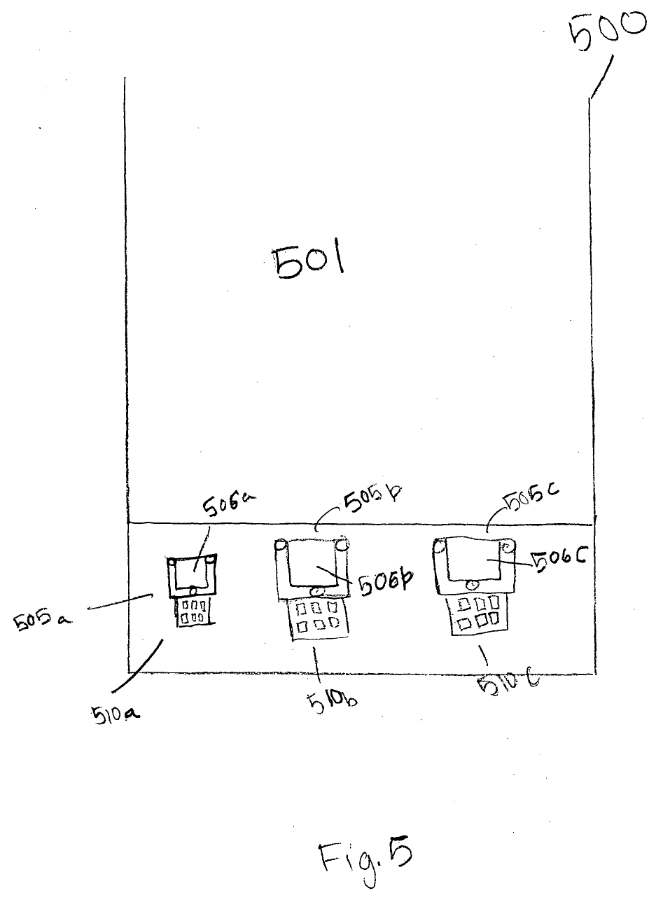

FIG. 4 illustrates a mechanism for shunting the selected rental item to the appropriate delivery port in accordance with one embodiment of the invention. Chute 400, shown in FIG. 4 is inclined at an angle sufficient to allow the selected rental item to slide down chute 400 in direction 401. If the selected rental item was selected from DPS 206a (as shown in FIG. 2), then door 402a will move in direction 403a to position 404a, allowing the selected rental item to proceed through physical connection 209a to delivery port 207a of UI 205a. Likewise, if the selected rental item was selected from DPS 206b, then door 402b will move in direction 403b to position 404b, allowing the selected rental item to proceed through physical connection 209b to delivery port 207b of UI 205b and if the selected rental item was selected from DPS 206c, then door 402c will move in direction 403c to position 404c, allowing the selected rental item to proceed through physical connection 209c to delivery port 207c of UI 205c.

There are many mechanisms by which the selected rental item may be delivered to the appropriate UI unit. Such mechanisms are known in the art and are not critical aspects of the inventive concepts claimed herein, and may assume various forms in accordance with alternative embodiments.

For one embodiment, there is no physical connection between the UI units and the RIS unit. Rather, upon selection of the rental item and completion of the rental transaction agreement, the selected rental item is deposited in a delivery port of the RIS unit and the user is provided with access to the delivery port via the DPS.

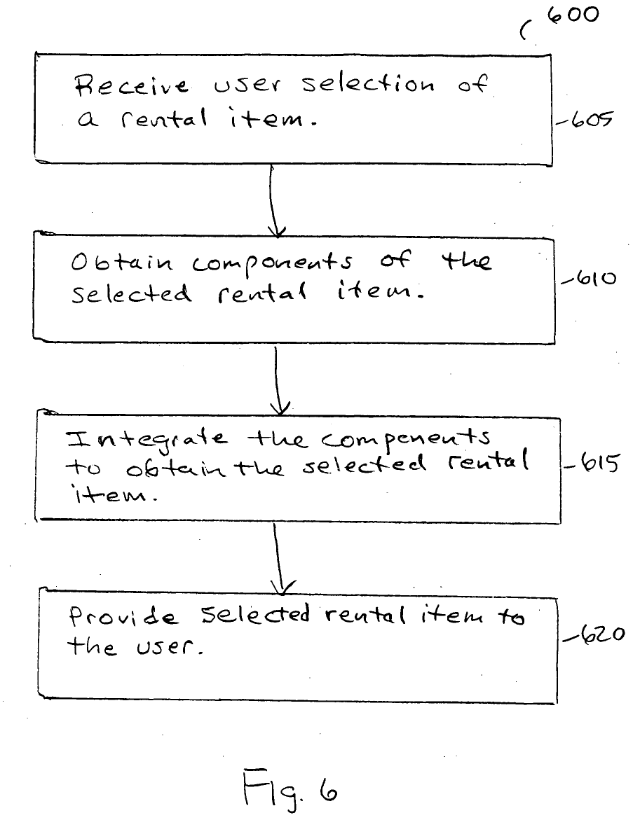

FIG. 5 illustrates a rental item storage unit with access-controlled delivery ports for providing a user access to a selected rental item deposited within a specified delivery port. RIS unit 500, shown in FIG. 5, includes rental item storage space 501 together with a dispensing mechanism (not shown). When a rental item is selected and dispensed as described above, it is dispensed to one of one or more delivery ports 505, shown as 505a-505c. Upon completion of the rental agreement transaction, the user is informed (via the DPS) which delivery port of the RIS unit the selected rental item has been delivered to, and the user may then proceed to the RIS unit and obtain the rental item. In accordance with one embodiment of the invention, and as shown in FIG. 5, the delivery port may have an access prevention mechanism such as a locked door 506 shown as doors 506a-506c. Access may be provided by entering a security code via a keypad 510, shown as keypads 510a-510c. In such an embodiment the user would not only be informed which delivery port of the RIS unit the selected rental item had been delivered to, but would also be provided with the security code to access the delivery port.

In the context of movie rentals, the embodiments of the invention discussed above provide the ability to store thousands of titles on DVD or cassette tape with limited storage space, provide abundant descriptive information about each title without physically displaying the DVD or cassette, and automatically complete a rental, including delivery of the rental item to the user, without a sales person

As the number of movie titles continues to grow and more video and audio content is made available for rent, even the reduced storage requirements of such embodiments may become impractical. To address this concern, embodiments of the invention provide methods and apparatuses for storing, components of the rental item separately, with some components stored proximately to the DPS and others stored proximately or remotely. The components are then integrated upon selection by the user.

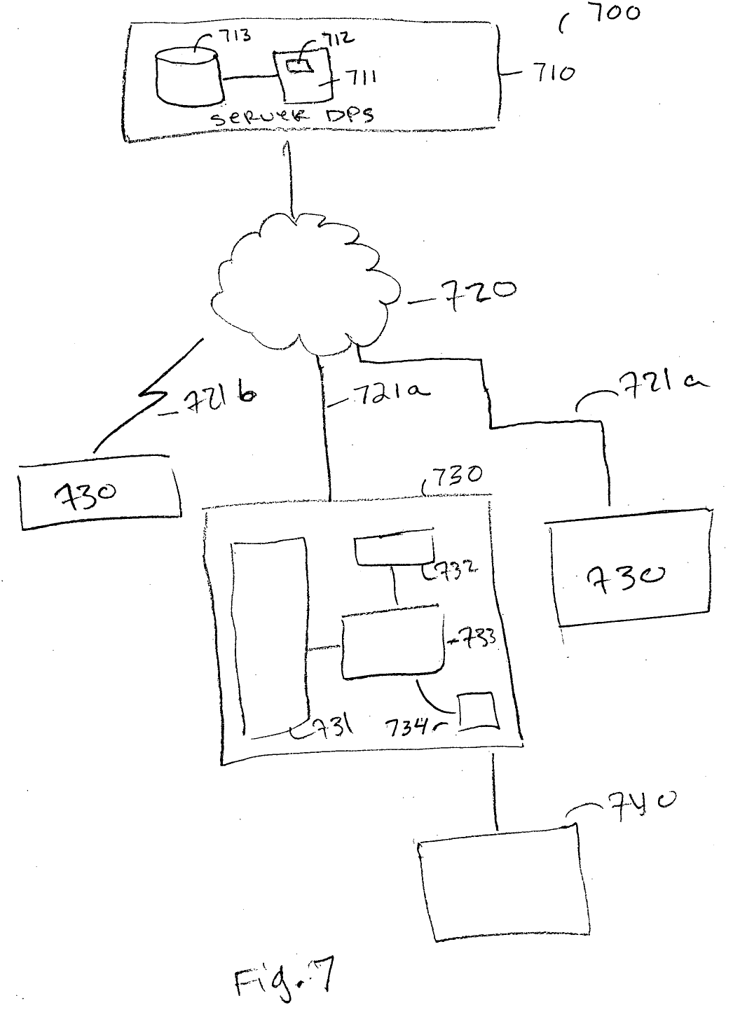

FIG. 6 illustrates a method by which a user selects a rental item, component portions of the rental item are integrated and the rental item provided to the user in accordance with one embodiment of the invention. Process 600, shown in FIG. 6, begins at operation 605 in which a user selection of a rental item is received. For example, the user selects a DVD to rent using a DPS in a manner as described above.

At operation 610 components of the rental item are obtained from storage. Some components of the rental item may be stored locally, while others may be stored locally or remotely. For example, if the user selects a movie to rent on DVD, a blank DVD disk is obtained from a disk storage facility. The disk may be dispensed as described above. In this case the disk is dispensed to a DVD “burner” (i.e., a DVD recording mechanism). The burner also obtains the digital information representing the video/audio content of the DVD. This information may be stored locally in a DPS, or may be obtained via a network from storage on a server DPS located remotely.

At operation 615 the components of the rental item are integrated to obtain the rental item desired. For example the DVD is burned with the selected movie through methods known in the art.

At operation 620, the integrated rental item is provided to the user. For example, once the DVD is burned with the selected movie, it is provided to the user as described above.

The method of FIG. 6 allows for the rental of items such as DVDs or audio disks with even less physical space dedicated to the storage of the rental items.

FIG. 7 illustrates system for receiving an audio or video rental selection and creating a corresponding rental item by recording the audio or video information to be recorded on a media and delivering the media to a user.

System 700, shown in FIG. 7 includes one or more rental item storage/integration (RISI) units 730. Each RISI 730 contains a media storage unit 731 that may contain, for example, a number of blank DVDs, CDs, or audio or video cassettes.

When a user selection is received from the UI unit 740, which may be located proximately or remotely in relation to the RISI unit 730, a blank media is dispensed from media storage unit 731 to media recording unit (e.g., DVD burner) 733 through methods described above or others known in the art. The media recording unit 733 receives the audio and or video information corresponding to the user's selection from an information storage device 732 and records the information on the media thus creating the selected rental item. The selected rental item is then dispensed to delivery port 734 of the RISI unit 730, and may be further dispensed to a delivery port of the UI unit 740 as described above.

It may not be practical to store all of the audio and/or video information corresponding to the numerous possible user selections. In such case the information may be stored on a server DPS 710 which may be remotely located in relation to the RISI unit 730. For example, server DPS 710, which may include a processor 711, a processor memory 712, and a mass storage memory 713, may be remotely located and coupled to RISI unit 730 via Internet 720. Each of the RISI units 730 may be coupled to the server DPS 710 via wired communication links (e.g., 721a) or wireless communication links (721b). Internet 720 is a network of networks through which information is exchanged by methods well known in the art (e.g., the use of TCP and IP protocols, etc.)

Thus, system 700 allows a user to select a rental item from virtually limitless audio and video presentations while requiring only limited physical storage space. For example, the number of blank DVDs that need be stored is limited by the number of expected rental transactions in a given time. Therefore, for example, if 2,000 rental transaction may be expected per day, the RISI unit need only store 2,000 blank DVDs which are then replenished daily. In this way, the portion of system 700 that requires commercial space may be reduced to the size of a large bookshelf.

Embodiments of the invention described in reference to FIGS. 6 and 7 presents the drawback of waiting for the rental item components to be integrated. However, this time may be no more than time typically spent waiting in line at a video rental store. Moreover, for one embodiment, the user may select a video or audio presentation to rent from their personal computer via the Internet. The selected item is then integrated from its components during the time the user travels from, for example, their home, to the location of the RISI unit. The user may then access the selected rental item as described above in reference to FIG. 5.

In an alternative embodiment, the system described in reference to FIG. 7 is integrated with, and complements the system described in reference to FIG. 2. In such an embodiment, many of the most popular selections may be stored in a RIS unit as described in reference to FIG. 2. For example in the context of video rental, when storing DVDs it may be practical to store several copies of a popular movie. However at some point the several copies stored may all be rented. A subsequent user wishing to select the popular movie may be informed that the selection is not available. To avoid this lost business, without increasing storage limits to impractical levels, a RISI unit as described in reference to FIG. 7 is incorporated into the automated rental transaction system. Thus, only those users wishing to rent a particular DVD after the number of stored copies has been rented will be subject to the delay of integration of the components of the rental item (i.e., burning the DVD). Also, it may not be practical to store physical copies of less popular presentations such as for example, old television shows or foreign language movies. Still it may be commercially beneficial to offer such presentations for rent. In such cases these presentations may be provided via an incorporated RISI unit.

Through the use of such an incorporated system, a large majority of rental transactions could be accomplished fairly quickly, while only the smaller percentage (i.e., less popular selections or selections of which the stored physical copies have already been rented) may be subject to delay.

General Matters

Embodiments of the invention have been described in the context of rental items. For alternative embodiments of the invention, the inventive concepts disclosed herein may be applied to commercial transactions other than renting items (e.g., items being sold and not rented. For example, embodiments of the invention may be used to vend music disks to consumers without maintaining a costly commercial establishment.

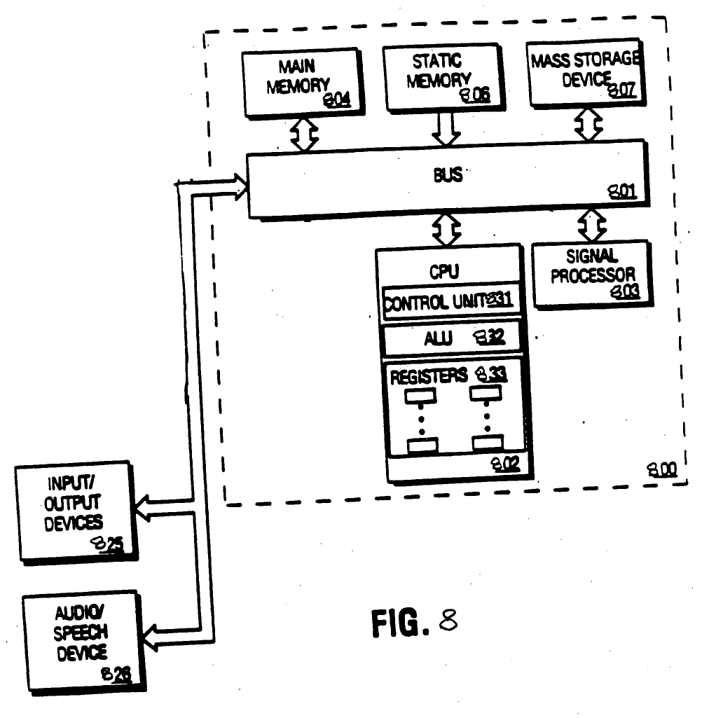

Embodiments of the invention require the use of a DPS to effect user selection of a rental item, the completion of the rental transaction agreement, and/or the exchange of video and/or audio content, among other uses. FIG. 8 is a block diagram illustrating one embodiment of a DPS 800 that may be used to access descriptive information regarding rental items, complete and effect rental transaction agreements, provide a user with access information, and exchange audio and/or video content in accordance with various embodiment of the present invention. For alternative embodiments of the present invention, processing system 800 may be a personal, or portable computer.

The components of processing system 800 are exemplary in which one or more components may be omitted or added. For example, one or more memory devices may be utilized for processing system 800.

Referring to FIG. 8, processing system 800 includes a central processing unit 802 and a signal processor 803 coupled to a main memory 804, static memory 806, and mass storage device 807 via bus 801. Processing system 800 may also be coupled to input/output (I/O) devices 825, and audio/speech device 826 via bus 801. Bus 801 is a standard system bus for communicating information and signals. CPU 802 and signal processor 803 are processing units for processing system 800. CPU 802 or signal processor 803 or both may be used to process information and/or signals for processing system 800. CPU 802 includes a control unit 831, an arithmetic logic unit (ALU) 832, and several registers 833, which are used to process information and signals. Signal processor 803 may also include similar components as CPU 802.

Main memory 804 may be, e.g., a random access memory (RAM) or some other dynamic storage device, for storing information or instructions (program code), which are used by CPU 802 or signal processor 803 to store and communicate rental item descriptions, rental transaction agreement information, and rental item access information, as well as any other information necessary to complete a rental transaction. Main memory 804 may store temporary variables or other intermediate information during execution of instructions by CPU 802 or signal processor 803. Static memory 806, may be, e.g., a read only memory (ROM) and/or other static storage devices, for storing information or instructions, which may also be used by CPU 802 or signal processor 803. Mass storage device 807 may be, e.g., a hard or floppy disk drive or optical disk drive, for storing information or instructions for processing system 800.

An item description function, as well as functionality to effect a rental or purchase agreement, in accordance with the present invention can be implemented by hardware and/or software contained within computing system 800. For example, CPU 802 or signal processor 803 can execute code or instructions stored in a machine-readable medium, e.g., main memory 804. For various embodiments of the invention, the memory 806 or mass storage device 807 may be used to store valid address portions, valid addresses, or some representation of thereof. The memory 806 may be used to store the instructions to effect the comparison of input address portions or combinations thereof with corresponding valid address portions or combinations thereof.

The invention includes various operations. The operations of the invention may be performed by hardware components or may be embodied in machine-executable instructions, which may be used to cause a general-purpose or special-purpose processor or logic circuits programmed with the instructions to perform the operations.

Alternatively, the steps may be performed by a combination of hardware and software. The invention may be provided as a computer program rental item that may include a machine-readable medium having stored thereon instructions, which may be used to program a computer (or other electronic devices) to perform a process according to the invention. The machine-readable medium may include, but is not limited to, floppy diskettes, optical disks, CD-ROMs, and magneto-optical disks, ROMs, RAMs, EPROMs, EEPROMs, magnet or optical cards, flash memory, or other type of media/machine-readable medium suitable for storing electronic instructions. Moreover, the invention may also be downloaded as a computer program rental item, wherein the program may be transferred from a remote computer to a requesting computer by way of data signals embodied in a carrier wave or other propagation medium via a communication cell (e.g., a modem or network connection). All operations may be performed at the same central cite or, alternatively, one or more operations may be performed elsewhere.

Each of the rental item storage units described in the various embodiments may also contain a rental item return port through which the user deposits the rental item at the end of the rental period. In alternative embodiments, a rental item return receptacle may be separate from the rental item storage unit. For such embodiments, the rental item return receptacle may be located proximately or remotely in relation to the automatic rental transaction system.

Embodiments of the invention described in relation to FIGS. 6 and 7, in which a DVD is burned for every rental transaction may result in numerous DVDs which the provider may not want returned. In such cases, in order to effect a rental, and not a sale, of the audio or video presentation, the presentation information may be recorded on a temporary DVD media as known in the art. Such media degrades after a specified time (e.g., approximately the time of the rental period). After the specified time the presentation information is no longer displayable. For one embodiment of the invention the non-usable DVD may be returned to a provider's receptacle for recycling and may result in a token “deposit” payment to the user for its return.

For such embodiments, audio and/or video presentations may be recorded on degradable media having varying degradation time periods. For example, the media may degrade after 2 days, or after 14 days. The degradation time may also be a function of use, for example the media may degrade after 1 use or after 10 uses. For such embodiments, the rental fee is based on the media degradation rate (based on time or use). For example, the user would then select not only the audio or video presentation (e.g., the movie), but would also select the rental period and be charged accordingly.

Embodiments of the invention have been described in the context of automatically providing rented consumer items such a DVD movies that can be stored proximate to the UI and delivered directly to a user at, or very near to, the UI. However, alternative embodiments of the invention may allow the user to complete a rental transaction and obtain the rented item at another location. For example, the user may complete the rental transaction including verifying identity and rental payment method at the UI. The finalization of the rental transaction may provide the user with access means to the rental item, which is stored remotely from the UI. For example, the after completing the rental transaction, the user may receive an access code to a remote storage facility containing the rental item. The user would then travel to the storage facility and use the access code to gain access to and take possession of the rental item.

For example, consider a rental car service. A user may complete and finalize the rental transaction for a UI in accordance with aspects of embodiments of the invention described above. The UI may be the user's own digital processing system (e.g., PC) or may be a digital processing system provided by the vendor. Upon completion of the rental transaction the user may be provided with the location of the selected car as well as the door lock code for the selected car. The user may then proceed to the location provided, use the door lock code to access the car, find the ignition key in a pre-designated location within the car and take possession of the car.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

1. A method comprising:
providing a list of items via a digital processing system;
receiving a selection of an item, from a user, via the digital processing system;
effecting a commercial transaction agreement in regards to the selected item; and
automatically providing the user with access to the selected item via the digital processing system.

2. The method of claim 2 wherein automatically providing the user with access to the selected item includes providing the user with information to access the item.

3. The method of claim 1 wherein the item is provided to user proximate to the digital processing system.

4. The method of claim 3 wherein the item comprises a data storage medium having stored data thereon.

5. The method of claim 1 wherein components of the item are integrated upon effecting the commercial transaction agreement.

6. The method of claim 1 wherein the list of items provided includes descriptive information of each item.

7. The method of claim 3 wherein the data storage medium is selected form the group consisting of audio disks, video disks, audio tapes, video tapes, compact disks, and digital video disks.

8. An apparatus comprising:
at least one user interface unit including a digital processing system for providing a list of items to a user, receiving a selection of an item from the user, and effecting a commercial transaction agreement in regards to the selected item;
a storage unit for storing a plurality of items; and
a delivery mechanism for providing the selected item to the user.

9. The apparatus of claim 8 wherein the item is provided to user proximate to the digital processing system.

10. The apparatus of claim 9 wherein the item comprises a data storage medium having stored data thereon.

11. The apparatus of claim 8 wherein components of the item are integrated upon effecting the commercial transaction agreement.

12. The apparatus of claim 8 wherein the list of items provided includes descriptive information of each item.

13. The apparatus of claim 3 wherein the data storage medium is selected form the group consisting of audio disks, video disks, audio tapes, video tapes, compact disks, and digital video disks.

14. A method for vending items comprising:
displaying a plurality of items to a user via a digital processing system, the digital processing system communicatively coupled to a vending apparatus;
receiving a selection of an item from a user via the digital processing system;
effecting a commercial transaction in regard to the selected item via the digital processing unit;
and providing the selected item to the user via the vending apparatus.

15. The method of claim 14 wherein the commercial transaction is a rental transaction.

16. The method of claim 15 wherein the items comprise data storage media selected form the group consisting of audio disks, video disks, audio tapes, video tapes, compact disks, and digital video disks.

17. The method of claim 16 wherein providing the selected rental item to the user includes providing the user with an identification of a particular delivery port of the vending apparatus.

18. The method of claim 16 wherein providing the selected rental item to the user further includes providing the user with access information to access the particular delivery port.

19. The method of claim 14 further comprising:
integrating two or more components of the selected item after effecting the commercial transaction in regard to the selected item and prior to providing the selected item to the user.

20. The method of claim 19 wherein one or more components of the selected item are stored remotely from the vending apparatus.
